(19) United States
(12) Patent Application Publication
(10) Pub. No.: US 2007/0242043 A1
(43) Pub. Date: Oct. 18, 2007

(54) CONTACTLESS ELECTRON JOYSTICK OF UNIVERSAL JOINT STRUCTURE USING SINGLE HALL SENSOR

(76) Inventors: Jae Woo YANG, Daejun (KR); Jang Myung LEE, Busan (KR); Hyo Moon LEE, Busan (KR); Joon Young CHOI, Busan (KR); Hong Zhe JIN, Busan (KR)

Correspondence Address: IPLA P.A., 3580 WILSHIRE BLVD., 17TH FLOOR, LOS ANGELES, CA, 90010, US

(21) Appl. No.: 11/425,659

(22) Filed: Jun. 21, 2006

(30) Foreign Application Priority Data
Apr. 17, 2006 (KR) 10-2006-0034362

(51) Int. Cl. G09G 5/08

(52) U.S. Cl. 345/161

(57) ABSTRACT

A contactless joystick of a universal joint structure using a single hall sensor is disclosed, in which a two-dimension coordinate of an end of a joystick bar is obtained based on a principle that a rotation of a horizontal vector of a magnetic field is detected using a hall sensor, and a human body engineering design can be obtained with a universal joint structure, and it is easy to diagnose a certain failure with its simple structure, and a simple assembly is obtained, and work efficiency can be maximized, and an enhanced vibration resistance structure is obtained.

### TECHNICAL FIELD

The present invention relates to a contactless joystick of a universal joint structure using a single hall sensor, and in particular to a contactless joystick of a universal joint structure using a single hall sensor in which a two-dimension coordinate of an end of a joystick bar is obtained based on a principle that a rotation of a horizontal vector of a magnetic field is detected using a hall sensor, and a human body engineering design can be obtained with a universal joint structure, and it is easy to diagnose a certain failure with its simple structure, and a simple assembly is obtained, and work efficiency can be maximized, and an enhanced vibration resistance structure is obtained.

### BACKGROUND ART

FIG. 1 is a perspective view illustrating a conventional electron joystick structure having two sensor structures.

As shown therein, in a conventional contactless electron joystick, a hall sensor is engaged at rotation axes x and y of a joystick bar, and a rotation angle of a permanent magnet corresponding to each axis is converted into a two-dimension vector value. With this structure, an accuracy of a signal measurement is enhanced, and an operation can be performed in real time since a complicated signal process and compensation process are not needed. However, a nonlinear operation is performed in a two-dimension motion between a hall sensor output signal and an end of a joystick bar. In addition, in the above two hall sensor structures, since a permanent magnet is provided at each rotary shaft for measuring rotation angles, a design dimension increases, and an apparatus design may be more complicated due to a vibration resistance design.

To overcome the above problems, a new joystick having a rotation assembly of FIG. 2 is developed.

FIG. 2 is a perspective view illustrating a conventional electron joystick structure having a single hall sensor structure. As shown therein, a hall sensor is arranged at a spherical center of a joystick bar, and a bar shaped permanent magnet is installed at a lower side of a bar. In this structure, a magnetic force line of a permanent magnet is always oriented toward a rotation center, and a two-dimension detection area is formed with respect to a joystick bar by a hall sensor positioned at a spherical center of the rotation assembly. An output signal of a hall sensor helps forming a two-dimension detection area with respect to a joystick bar. An output signal of a hall sensor is in proportion to a horizontal vector of a magnetic field generated by a permanent magnet. When the rotation range of a joystick bar is limited at ±30° with respect to a vertical axis, a high linearity is obtained at ±360°, namely, in all directions.

However, in the above structure, the rotation assembly needs a huge volume in the whole installation areas of the apparatus. Since the above structure should be supported by each rotation assembly, a high strength material should be needed in consideration with a friction force, a vibration resistance structure, etc. Since a desired linearity is obtained only when the magnetic force line is oriented toward the center of the rotation, a high accuracy is needed during an apparatus process. A magnetic force line of a permanent magnet may have a certain eccentric formation, while deviating from a center of a hall sensor plane due to an abrasion of rotary shaft after a long time use, so that accuracy may be disadvantageously affected. Since the above deviation may be variable based on a user or a use environment, a real time compensation cannot be performed.

### DISCLOSURE OF THE INVENTION

Accordingly, it is an object of the present invention to provide a contactless electron joystick of a universal joint structure using a single hall sensor which overcomes the problems encountered in the conventional art.

It is another object of the present invention to provide a contactless electron joystick of a universal joint structure using a single hall sensor in which a bar shaped permanent magnet engaged at a lower side of a joystick bar helps forming a horizontal vector with respect to an axial direction magnetic flux of a bar magnet on a two-dimension plane of a hall sensor in sync with an operation of a universal joint, and the hall sensor detects a horizontal vector for thereby controlling a direction and speed of a control object such as a motored wheel chair.

It is further another object of the present invention to provide contactless electron joystick of a universal joint structure using a single hall sensor in which a human body engineering design-based easier use is obtained with the use of a universal joint structure, and it is easy to diagnose failures with its simple structure, and an assembling process is simple, and work efficiency may be maximized, and an enhanced vibration resistance structure is obtained.

To achieve the above objects, there is provided a contactless electron joystick of a universal joint structure using a single hall sensor characterized in that a bar shaped permanent magnet engaged at a lower side of a joystick bar helps forming a horizontal vector with respect to a magnetic flux of an axial direction of a bar magnet on a two-dimension plane of a hall sensor in sync with an operation of a universal joint, and the hall sensor detects a formation of the horizontal vector for thereby controlling a direction and speed of a control object such as a motored wheel chair, etc.

The contactless electron joystick includes an x-axis input buffer which has a first buffer for receiving a signal having a phase difference of 90° corresponding to an x-axis component of a direction of a magnetic field and a second buffer for receiving an inner reference voltage of the hall sensor of an x-direction; a y-axis input buffer which has a third buffer for receiving a signal having a phase difference of 90° corresponding to a y-axis component of a direction of a magnetic field and a fourth buffer for receiving an inner reference voltage of the hall sensor of a y-direction; a reference voltage buffer which has fifth and sixth buffers for generating reference voltages of x-direction and y-direction of an inner side of a controller circuit; a low pass filter which has a seventh buffer for receiving an output signal of the first buffer through its one side and the output signals of the second buffer and fifth buffer from its other side, and an eighth buffer for receiving an output signal of the third buffer and the output signals of the fourth buffer and sixth buffer through its other side, for thereby performing a differential amplification and low pass filtering with respect to a difference between an inner reference voltage of the controller circuit and a reference voltage of the hall sensor; and a signal converter circuit provided for an output of the hall sensor, said signal converter circuit including an output buffer which has a ninth buffer and a tenth buffer for buffering the output signals of the seventh buffer and the eighth buffer and for outputting the same.

In a nonlinear characteristic between an output signal of the hall sensor and a motion of the joystick bar,

$$A {D}_{x} = ξ \frac{sin ( θ )}{1 + {( k \cdot θ )}^{n}} cos ( α ) , \\ A {D}_{y} = ξ \frac{sin ( θ )}{1 + {( k \cdot θ )}^{n}} sin ( α ) \qquad ( formula 4 )$$

is obtained from the following formulas 1, 2 and 3

$$\begin{matrix}{B}_{h} = λ ( θ ) B sin ( θ ) & ( formula 1 ) \\ λ ( θ ) = \frac{1}{1 + {( k θ )}^{n}} & ( formula 2 ) \\ {V}_{x} = c {B}_{x} cos ( α ) = \frac{c λ ( θ ) B cos ( α )}{{D}^{2}} \\ {V}_{y} = c {B}_{y} sin ( α ) = \frac{c λ ( θ ) B sin ( α )}{{D}^{2}} , and & ( formula 3 ) \\ A {D}_{out} \pm \sqrt{ A {D}_{x}^{2} + A {D}_{y}^{2}} = ξ \frac{sin ( θ )}{1 + {( k θ )}^{n}} & ( formula 5 )\end{matrix}$$

is obtained from the above formula 4,

where \vec{B} represents a magnetic flux density of an axial direction of a permanent magnet, and \vec{Bₕ} represents a horizontal vector of a magnetic flux of an axial direction of a permanent magnet, and k is a parameter which determines a linear range, and θ_{c} represents a maximum linear range, and n represents a linearity, and L represents a length of a permanent magnet, and D represents a vertical distance between an end portion of a permanent magnet and a hall sensor, and θ represents an inclination of a joystick bar, and λ(θ) represents a nonlinear function with respect to an inclination of a joystick bar, and α represents a rotation angle of a joystick bar, and ξ represents a constant value which is in constant proportion to an amplification coefficient of a signal converter circuit, and c represents an amplification coefficient of a signal converter circuit, and N represents a resolution of an A/D converter, and V_{ref} represents a reference voltage of an A/D converter.

The maximum linear range θ_{c} has the following formula,

$${θ}_{c} = \frac{π}{2} [ 1 - exp ( - S \frac{D}{L} ] \qquad ( formula 6 )$$

and, a parameter k, which determines a linear range, has the characteristic of the following formula,

$$k \approx {⌊ \frac{1}{n {θ}_{c}^{n - 1} tan ( {θ}_{c} ) - {θ}_{c}^{n}} ⌋}^{\frac{1}{n}} \qquad ( formula 7 )$$

A constant value ξ, which is in constant proportion to an amplification coefficient of the signal converter circuit, has the following formula,

$$\frac{{V}_{x}}{A {D}_{x}} = \frac{{V}_{y}}{A {D}_{y}} = \frac{c \cdot B}{ξ {D}^{2}} = \frac{{V}_{ref}}{{2}^{N} - 1}$$

(formula 8) based on the formulas 3 and 4, and has the characteristic of the following formula,

$$ξ = \frac{c ( {2}^{N} - 1 ) B}{{D}^{2} {V}_{ref}} . \qquad ( formula 9 )$$

In a nonlinear compensation with respect to an output of the sensor and an inclination of the joystick bar, the following formula 12,

$${θ}_{m + 1} = {θ}_{m} - \frac{A {D}_{out} {k}^{2 n} {θ}_{m}^{2 n} + [ {k}^{n} ξsin ( {θ}_{m} ) - 2 {k}^{n} A {D}_{out} ] {θ}_{m}^{n} + ξsin ( {θ}_{m} )}{[ {k}^{n} ξcos ( {θ}_{m} ) ] {θ}_{m}^{n} - [ n {k}^{n} ξsin ( {θ}_{m} ) ] {θ}_{m}^{n - 1} + ξcos ( {θ}_{m} )}$$

is obtained from the following formulas 10 and 11,

$${x}_{m + 1} = {x}_{m} - \frac{f ( {x}_{m} )}{{f}^{′} ( {x}_{m} )} , m = 0 , 1 , 2 , Λ \qquad ( formula 10 )$$

|xₘ₊₁−xₘ|<ε₁ (formula 11), and thus

|θₘ₊₁−θₘ|<ε₂ (formula 13) is obtained,

where ε₁ represents a set error range, and α₂ represents a set error range.

### BRIEF DESCRIPTION OF THE DRAWINGS

The present invention will become better understood with reference to the accompanying drawings which are given only by way of illustration and thus are not limitative of the present invention, wherein;

FIG. 1 is a perspective view illustrating a conventional electron joystick having two sensor structures;

FIG. 2 is a perspective view illustrating a conventional electron joystick having a single hall sensor structure;

FIG. 3 is a view illustrating a construction of a contactless electron joystick of a universal joint structure using a single hall sensor according to the present invention;

FIG. 4 is a view illustrating an arrangement of a magnetic flux density distribution of a permanent magnet and a hall sensor according to the present invention;

FIG. 5 is a circuit diagram illustrating a signal converter circuit with respect to a hall sensor output according to the present invention;

FIG. 6 is a graph of a non-linear characteristic analysis with respect to an invariable parameter value for Formula 5 according to the present invention;

FIG. 7 is a table of a relation between a linear range θ_{c} and a vertical distance D based on a quantitative method according to the present invention;

FIG. 8 is a view of a result of a variable principle between a linear range based on a joystick design index change and a parameter value which determines a linear range, which is shown in a 3D, according to the present invention;

FIG. 9 is a graph of a result of a 10^{th} order polynomial of a nonlinear experimental curve with respect to an output of a signal converter circuit of a hall sensor and a sine value of a joystick inclination θ based on a least square approximation method according to the present invention;

FIG. 10 is a graph for describing a coincidence of a numerical analysis of a 10^{th} order polynomial and a nonlinear correction formula (formula 5) with respect to an experimental curve according to the present invention;

FIG. 11 is a graph illustrating a coincidence of a result of simulation and an actual experimental curve based on a nonlinear correction formula (formula 5) according to the present invention;

FIG. 12 is a block diagram for describing each function module of a joystick electronic controller according to the present invention; and

FIG. 13 is a photo of a contactless electron joystick of a universal joint structure using a single hall sensor according to the present invention.

### MODES FOR CARRYING OUT THE INVENTION

In the present invention, a bar shaped permanent magnet 33 engaged at a lower side of a joystick bar helps forming a horizontal vector 34 with respect to an axial direction of a bar magnet on a two-dimension plane of a hall sensor 32 in sync with an operation of a universal joint 31. The hall sensor detects the horizontal vector for thereby controlling a direction and speed of a control object such as a motored wheel chair.

A nonlinear relation is basically obtained between a sensor output signal and a motion of a joystick bar based on a design specification in a joystick structure according to the present invention. The above nonlinear effect may be expressed as a change of a linear range, a change of a signal width, and a change of linearity with respect to a curve in a linear range.

Assuming that geometrical features related with a sensor structure are determined, and a shape and magnetic response intensity of a magnetic magnet are determined, an output signal of a hall sensor may change based on a certain rule in accordance with a movement of joystick, so that the above nonlinear indexes maintain constant values.

An analysis and determination process is needed with respect to parameter values which represent various physical elements so as to analyze nonlinear features based on a magnetic flux density distribution with respect to a permanent magnet, and a physical characteristic of a hall sensor, so that complexity increases.

Therefore, in the present invention, while avoiding a complicated modeling process based on a physical theory, a nonlinear function λ(θ) having a certain hereditary based on a linear range θ_{c}, a signal width ξ, and a linearity n of a nonlinear curve is used, so that the characteristics of a hall sensor output signal is analyzed based on a motion of a joystick bar, and a new compensation algorithm based on a nonlinear correction formula is obtained.

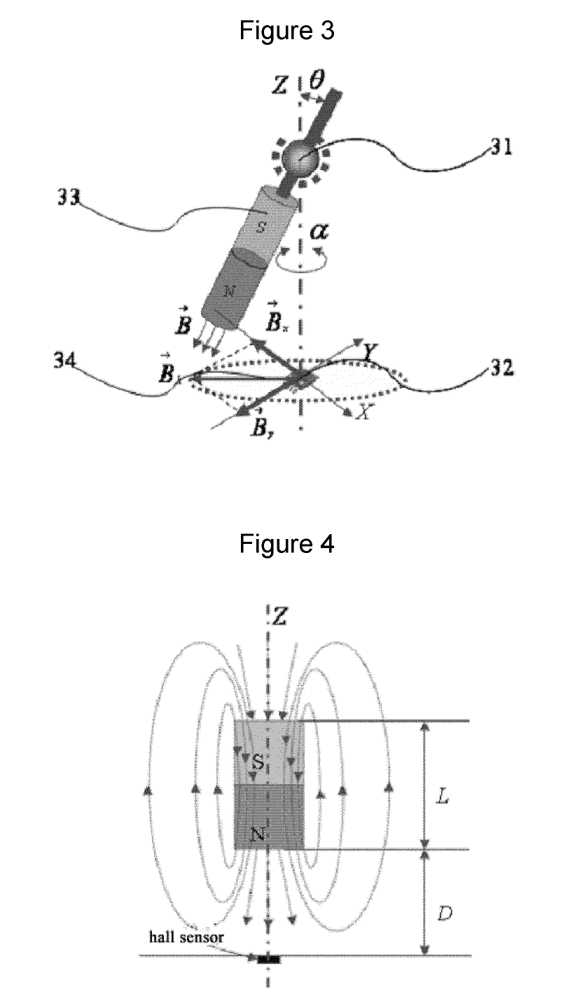

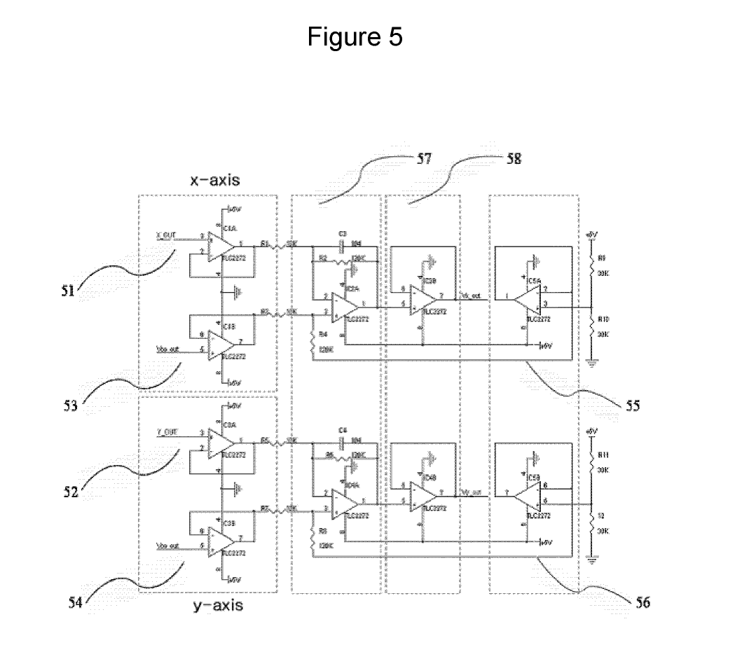

As shown in FIG. 3, the hall sensor outputs a signal (51, 52 of FIG. 5) having a 90° phase difference corresponding to x and y axes components in the direction of the magnetic field. There is provided an offset voltage having a certain deviation based on a change of an external environment such as temperature. An offset voltage is maintained with respect to a reference voltage (54 of FIGS. 5 and 3) based on an external magnetic field effect and an electromagnetic wave noise even in a state that a magnetic field is not provided. The above feature becomes a reason which affects a measurement error.

As shown in FIG. 5, a differential amplification and low pass filter 57 is formed based on a difference between a reference voltage 55, 56 of the interior of the controller circuit and a hall sensor reference voltage 53, 54, so that a signal, which does not have an offset voltage and a noise component, is obtained.

With each function module of a signal converter circuit, an optimum design of a simple circuit with separate buffers is obtained, so that a signal flow uniformity and hardware-based independency are achieved, whereby a failure occurring at one function module does not affect to other modules, and an easier maintenance is obtained.

The construction and operation of preferred embodiments of the present invention will be described with reference to the accompanying drawings. In the descriptions of the present invention, reference numerals are expressed with two digits of which a first digit represents the sequence of drawings, and a second digit represents the sequence of each element of the drawings. For example, in FIG. 3, since a first element is a universal joint, reference numeral 31 is given. In the remaining other drawings, the above rules are provided in the same manner.

### Embodiment

FIG. 3 is a view illustrating a construction of a contactless electron joystick of a universal joint structure using a single hall sensor according to the present invention.

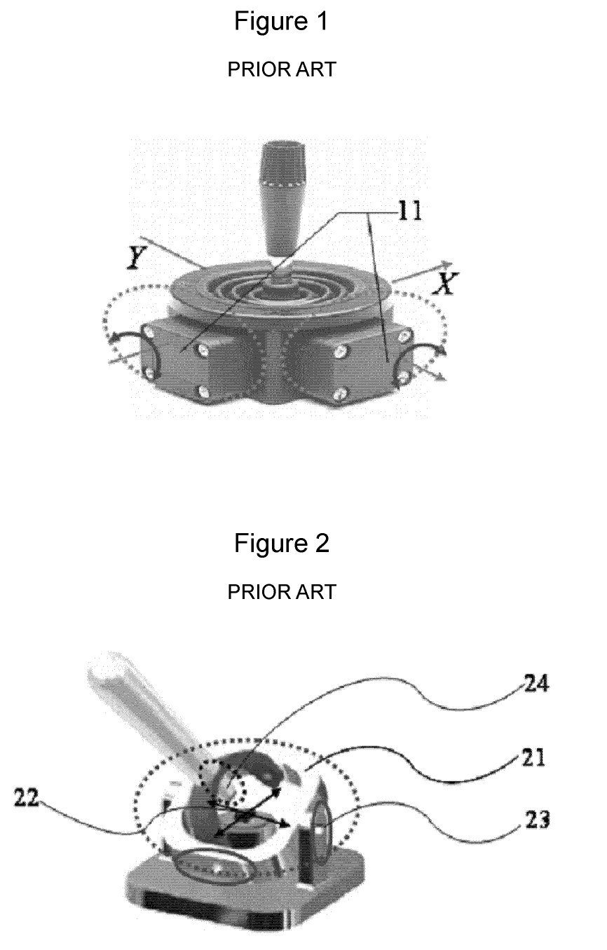

In the present invention as compared to the conventional joystick structure of FIG. 1, the magnetic force lines of the permanent magnet are oriented toward the rotation center of the universal joint 31. When the permanent magnet is inclined at θ by the motion of the universal joint 31, the magnetic response intensity \vec{B} of the center line helps forming a horizontal vector \vec{Bₕ} 34 on the plane of the hall sensor 32, and the horizontal components Bₓ, B_{y} are detected at the center of the plane of the hall sensor 32. Here, the hone sensor 32 outputs a signal having a phase of 90° corresponding to two components. Bₓ, B_{y} may be expressed as follows.

Bₕ=λ(θ)B sin(θ) [Formula 1]

where λ(θ) represents a function which represents a nonlinear effect formed based on the distribution characteristic of the magnetic force line of the permanent magnet 33 and the inclination of the joystick bar. If the magnetic flux density distribution of the permanent magnet is uniform and parallel with the direction of the joystick bar, λ(θ) is satisfied. However, as the inclination θ increases, the horizontal vector \vec{Bₕ} does not constantly increase but decreases when it gets out of a certain linear range.

The direction of the magnetic force line is nearly matched with the direction of the centerline in the interior of the bar shaped permanent magnet 33, and the magnetic response intensity has the maximum value. However, the distribution of the magnetic force line is oriented toward the S-pole from the N-pole of the permanent magnet 33 in the outer side. Namely, the direction of the magnetic force line of the inner side is opposite to the direction of the magnetic force line of the outer side. In the outer side, as it gets far from the center line of the permanent magnet, the magnetic flux intensity decreases.

When the permanent magnet 33 moves within a linear range, the hall sensor is surrounded by the magnetic force lines generated only by the N-pole. As the inclination θ increases, the horizontal vector \vec{Bₕ} increases. However, when it exceeds the linear range, as the inclination θ increases, the horizontal vector \vec{Bₕ} decreases because of a combined operation of the magnetic force line generated from the N-pole and the magnetic force line which is oriented toward the S-pole from the N-pole in the outside of the permanent magnet 33.

The nonlinear effect is directly related with a geometric structure of the joystick according to the present invention. As shown in FIG. 4, the geometric structure is achieved based on the length L of the permanent magnet, the vertical distance D between an end of the permanent magnet and the plane of the hall sensor at the home position, and the function of the inclination θ of the joystick bar. The nonlinear function λ(θ) may be modeled as the decrease function with respect to θⁿ based on the above features.

$$λ ( θ ) = \frac{1}{1 + {( k θ )}^{n}} \qquad [ Formula 2 ]$$

where n represents a linearity between a sine value of the inclination θ of the joystick bar and an output of the hall sensor and has an even number, and k represents a constant value based on a geometric characteristic of the permanent magnet, a magnetic response intensity, and a design specification of an apparatus.

Since the output voltages Vₓ, Y_{y} of the hall sensor is in linear proportion to the magnetic response intensities Bₓ, B_{y}, it may be obtained based on the following formula, where c represents an amplification coefficient of the signal converter circuit, and α represents a rotation angle of the joystick bar.

$${V}_{x} = c {B}_{x} cos ( α ) = \frac{c λ ( θ ) B cos ( α )}{{D}^{2}} \\ {V}_{y} = c {B}_{y} sin ( α ) = \frac{c λ ( θ ) B sin ( α )}{{D}^{2}} \qquad [ Formula 3 ]$$

The output signal of the hall sensor is processed with an amplification, a low pass filter 57, and an offset cancellation in the interior of a processor, so that it may be expressed as follow based on the formulas 1, 2 and 3.

$$A {D}_{x} = ξ \frac{sin ( θ )}{1 + {( k \cdot θ )}^{n}} cos ( α ) \\ A {D}_{y} = ξ \frac{sin ( θ )}{1 + {( k \cdot θ )}^{n}} sin ( α ) \qquad [ Formula 4 ]$$

where ξ represents an amplification coefficient of the signal converter circuit with respect to a sensor output and is a constant value which is in constant proportion to the magnetic response intensity at the center line of the permanent magnet and resolution of the A/D converter in the interior of the processor, and is in reverse proportion to the vertical direction D² and the reference value V_{ref} of the A/D converter.

In the present invention, the motion of the bar may be expressed in a two-dimension coordinate at the end of the permanent magnet based on the shape of the joystick structure and is in reverse proportion to sin(θ). As shown in the formula 4, since a nonlinear relationship is present between the A/D value and the sin(θ) processed by the processor, a linear compensation process with respect to the sin(θ) should be performed by the processor. As shown in FIG. 3, the rotation angle α with respect to the axis Z may be computed based on the A/D value, and the following nonlinear compensation formula may be obtained based on the formula 4.

$$A {D}_{out} \pm \sqrt{ A {D}_{x}^{2} + A {D}_{y}^{2}} = ξ \frac{sin ( θ )}{1 + {( k θ )}^{n}} \qquad [ Formula 5 ]$$

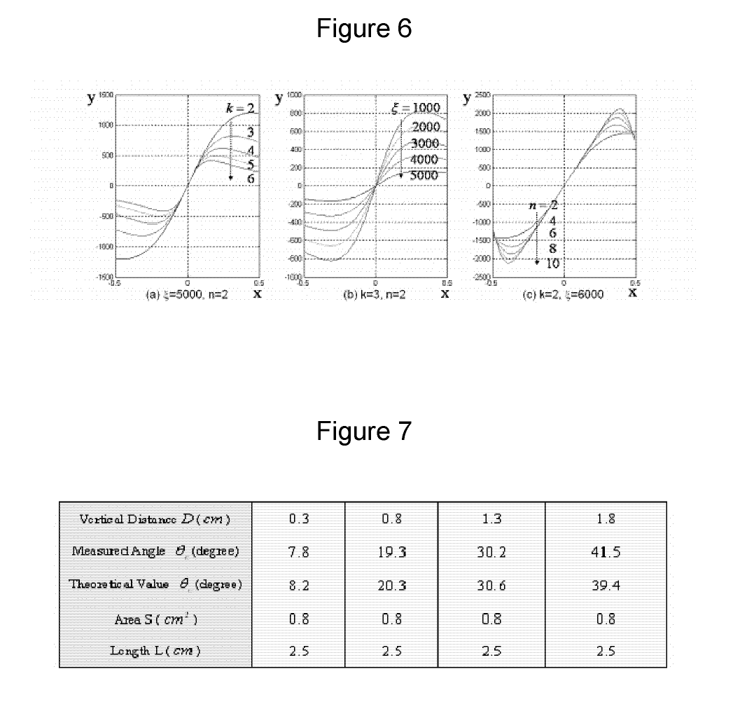

FIG. 6 is a result of the analysis with respect to the nonlinear characteristic based on the formula 5. As shown therein, the horizontal coordinate represents sin(θ), and the vertical coordinate represents the A/D value. As a result of (a) and (b), it is known that as the value k increases, the linear range decreases. Namely, k is an important parameter value for determining the linear range. (c) and (d) are a result of the simulation based on the change of the value n which represents the linearity. As the value n increases, the line becomes closer to the straight line within a set linear range.

As shown in FIG. 6, the inclination corresponding to the maximum value of the A/D value is defined as θ_{c}. In the joystick system, θ_{c} is an important performance index. As shown in FIG. 4, the linear range may change based on a proportion value change of the vertical distance D, the length L of the permanent magnet. When D increases in a state that L is fixed, θ_{c} increases, and on the contrary when D is fixed, and L increases, it is known that θ_{c} decreases as a result of the experiment.

In addition, when D and L are fixed, θ_{c} has a close relation with the area S of the end portion of the permanent magnet. When the area is large, since the magnetic force lines generated from the N-pole substantially surround the hall sensor, θ_{c} increases. When k=0 based on the formula 5,

$${θ}_{c} = \frac{π}{2}$$

is satisfied and expressed as the limit value of the linear range based on the joystick structure. θ_{c} may be modeled as follows based on the above experimental analysis and the change characteristic of the linear range based on the design indexes.

$${θ}_{c} = \frac{π}{2} [ 1 - exp ( - S \frac{D}{L} ] \qquad [ Formula 6 ]$$

θ_{c} represents inclination corresponding to the maximum A/D value in the formula 5. Since θ_{c} satisfies a condition that derivative with respect to the formula 5 is “0”, the relationship between the parameter value k and θ_{c}, which determine the linear range, may satisfy the following formula.

$$k \approx {⌊ \frac{1}{n {θ}_{c}^{n - 1} tan ( {θ}_{c} ) - {θ}_{c}^{n}} ⌋}^{\frac{1}{n}} \qquad [ Formula 7 ]$$

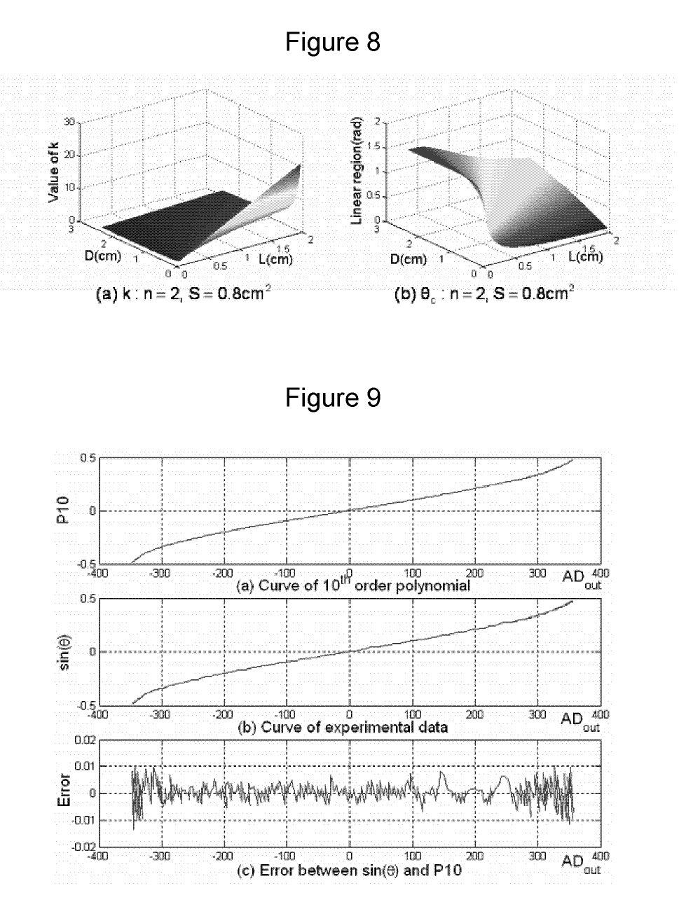

FIG. 7 is a table illustrating a relation between a linear range and a vertical distance and shows a change of θ_{c} based on the change of D and a result of the comparison between the theoretical value based on the formula 6 and the experimental value. In addition, FIG. 8 is a view illustrating a change rule of a linear range based on a joystick design index change and a parameter value which determines the linear range.

The signal converter circuit of the electronic controller performs an amplification with respect to an output signal of the hall sensor. Since it is processed in the interior of the processor by the A/d converter, ξ is in constant proportion to an amplification coefficient c and the resolution N of the A/D converter and has a close relation with a vertical distance between the end portion of the magnetic response intensity joystick bar of the permanent magnet and the hall sensor plane. The following formula may be obtained based on the formulas 3 and 4.

$$\frac{{V}_{x}}{A {D}_{x}} = \frac{{V}_{y}}{A {D}_{y}} = \frac{c \cdot B}{ξ {D}^{2}} = \frac{{V}_{ref}}{{2}^{N} - 1} \qquad [ Formula 8 ]$$

where ξ may be expressed as follows based on the formula 8.

$$ξ = \frac{c ( {2}^{N} - 1 ) B}{{D}^{2} {V}_{ref}} \qquad [ Formula 9 ]$$

As a method for increasing a proportion value of the vertical distance D and the length of the permanent magnet L during the design, the linear range θ_{c} is increased. In this case, an output signal of the signal converter circuit may decrease, so that the position accuracy of the end portion of the joystick bar decreases. When the design index of the joystick apparatus is determined, the value ξ may be used so as to increase the amplification coefficient c of the signal converter circuit modeled by the formula 9.

Since it is impossible to obtain the value sin(θ) from the A/D value measured by the processor based on the nonlinear compensation formula (formula 5), it is needed to obtain the value sin(θ) after the rotation angle θ of the joystick bar is obtained using the Newton method. In an actual application, a commercially available joystick is designed to have a bar rotation range within ±30°, sin(θ) has an unique value with respect to a certain value θ.

The Newton method has been widely used among many methods for obtaining a solution of the nonlinear equation f(x)=0 because it is simple and has a reliable convergence. When the function f(x) has a continuous derivative, it is possible to obtain a tangential equation of a curve y=f(x). Namely, in the Newton method, a desired numeral solution of the equation may be obtained by performing a repeating algorithm from a point in which the tangential line corresponding to a certain initial value meets with the X-axis. The repeating algorithm is as follows.

$${x}_{m + 1} = {x}_{m} - \frac{f ( {x}_{m} )}{{f}^{′} ( {x}_{m} )} , m = 0 , 1 , 2 , Λ \qquad [ Formula 10 ]$$

When a difference between the current value and a previously obtained value enters into a previously set error range based on the secondary convergence of the Newton method, an approximate solution, which satisfies f(x)=0, can be obtained.

|xₘ₊₁−xₘ|<ε₁ [Formula 11]

where ε₁ represents a set error range. With a result of the above conclusion, it is possible to obtain a numeral value with respect to the nonlinear compensation formula (formula 5).

$${θ}_{m + 1} = {θ}_{m} - \frac{\begin{matrix}A {D}_{out} {k}^{2 n} {θ}_{m}^{2 n} + [ {k}^{n} ξsin ( {θ}_{m} ) - \\ 2 {k}^{n} A {D}_{out} ] {θ}_{m}^{n} + ξsin ( {θ}_{m} )\end{matrix}}{\begin{matrix}[ {k}^{n} ξcos ( {θ}_{m} ) ] {θ}_{m}^{n} - [ n {k}^{n} ξsin ( {θ}_{m} ) ] {θ}_{m}^{n - 1} + \\ ξcos ( {θ}_{m} )\end{matrix}} \qquad [ Formula 12 ]$$

The computation is repeatedly performed until the following condition is satisfied. Here, ε₂ represents a previously set error range.

|θₘ₊₁−θₘ|<ε₁ [Formula 13]

The computation process with respect to the formula 13 is recursive, so that it needs a certain time period for obtaining numeral solutions. In addition, since the processor has a certain limit in computation speed, a real time computation is impossible, so that a straight interpolation method is more effective by forming a look table suing the measured A/D values for an actual application.

An interpolation polynomial obtained using the Lagrange interpolation method or the Newton interpolation method is a function which accurately passes through a given point. However, since the measurement value obtained based on experiment has many errors, it is preferably needed to obtain a function which is proper to the whole data as compared to an approximation function which accurately matches with a given point. The method for obtaining a curve, which represents the given data, is called an adaptation of a curve. In the present invention, a coincidence of a result of the compensation is certified with a nonlinear compensation formula based on an experimental curve with the least square approximation method.

Since the linear compensation is performed with respect to sin(θ) from the A/D value, a graph is formed in such a manner that the measurement value with respect to sin(θ) in the formula 5 from an experimental environment is determined as a vertical coordinate, and the measurement value with respect to ±\sqrt{ADₓ²+AD_{y}²} is determined as a horizontal coordinate.

The DC motor having an encoder is installed at the rotation axes x and y of the joystick bar, and a sine value is measured with respect to the rotation angle. Here, the encoder signal is inputted into the processors of the slaves A and B for thereby computing a rotation angle. The output of the hall sensor is inputted into a master processor through the amplification and filtering processes. A CAN network is provided between the slaves A and B and the master for thereby exchanging information in real time. In the present invention, the master receives a counted pulse value from the slaves A and B and is transmitted to a computer through the CAN communication, so that it is possible to obtain a nonlinear curve. In FIG. 9, (a) represents a result of 10^{th} order polynomial with respect to an actual experimental curve using the minimum square approximation method, and (b) represents an actual experimental curve.

In the nonlinear compensation formula (formula 5), the parameters k and ξ may directly affect the performance of the joystick system. If k and ξ are obtained based on the formulas 7 and 9, and the numeral value of the nonlinear compensation formula is matched with the value of 10^{th} order approximation polynomial using the least square approximation method, it is possible to describe the accuracy of the modeling method with respect to the nonlinear characteristic. The experimental method represents a process for certifying a coincidence with the adaptation curve of FIG. 9 after k and ξ are optimized. In addition, there is shown a result of comparison between the optimized value and the theoretical value.

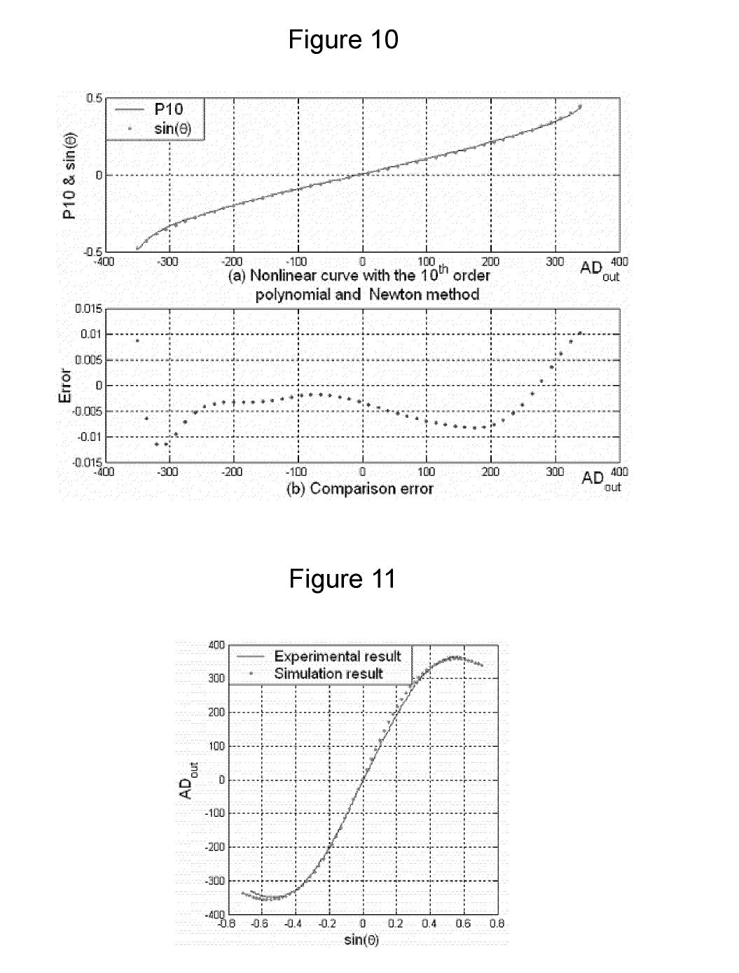

FIG. 10 is a graph for describing a coincidence of a numerical analysis of a 10^{th} order polynomial and a nonlinear correction formula (formula 5) with respect to an experimental curve according to the present invention and shows a result of the experiment with respect to a coincidence between the numeral solutions of the nonlinear compensation formula using the 10^{th} order polynomial and the Newton method based on the least square approximation method.

The experiment is performed under the conditions of D=1.3 cm, L=2.5 cm, S=0.8 cm², B=2000 Gauss, N=10, Vref=5, and c=40. After the optimization is performed, the values are k=1.639, ξ=1065, and the theoretical value based on the formula 7 is k=1.697, and the theoretical value based on the formula 9 is ξ=1136.

FIG. 11 is a graph illustrating a coincidence of a result of simulation and an actual experimental curve based on a nonlinear correction formula (formula 5) according to the present invention and shows a result of the comparison with respect to a coincidence between the change characteristic of the signal detected by the hall sensor and the nonlinear characteristic analysis performed based on the compensation formula in accordance with an inclination of the joystick bar.

As a result of the experiment, the vertical distance D and the amplification coefficient c of the signal converter circuit are optimized using the modeled formula with respect to k and ξ. Other parameter values are the same as the experimental condition of FIG. 10. The horizontal coordinate is sin(θ) and the vertical coordinate is an A/D value since an actual experimental value is directly compared without obtaining the numeral solution with respect to the nonlinear compensation formula (formula 5). Even when the rotation of the joystick bar exceeds the linear range, it is known that the nonlinear compensation formula accurately traces the change of the experimental curve.

In conclusion, the experimental curve inherently includes a small quantity of error components due to the noises which occur due an artificial element during a measurement with respect to an actual experimental curve, an inherent error of a measuring device, and a measuring environment, but as a result of the experiment it is known that the nonlinear compensation formula relatively accurately expresses a nonlinear shape.

FIG. 5 is a circuit diagram illustrating a signal converter circuit with respect to an output of a hall sensor. The signal converter circuit comprises a first buffer 51, a second buffer 53, a third buffer 52, a fourth buffer 54, a fifth buffer 55, a sixth buffer 56, a low pass filter 57 and an output buffer 58.

Here, the first buffer 51 receives a signal having a phase difference of 90° corresponding to an X-axis component of the direction of the magnetic field and buffers the same, and the second buffer 53 receives an inner reference voltage from the hall sensor in the X-direction.

In addition, the third buffer 52 receives a signal having a phase difference of 90° corresponding to the y-axis component of the direction of the magnetic field and buffers the same, and the fourth buffer 54 receives an inner reference voltage from the hall sensor in the y-direction and buffers the same.

The fifth and sixth buffers 55 and 56 are reference voltage buffers and generate the reference voltages of the x-direction and y-direction of the inner controller circuit.

The seventh buffer (x-direction of 57) receives an output signal of the first buffer 51 through its one side and buffers the same, and receives the output signals of the second buffer 53 and the fifth buffer 55 through its other side and buffers the same. The eighth buffer (y-direction of 57) receives an output signal of the third buffer 52 through its one side and buffers the same, and receives the output signals of the fourth buffer 54 and the sixth buffer 56 through its other side and buffers the same.

The low pass filter 57 comprises a seventh buffer (x-direction) and an eighth buffer (y-direction) which perform a differential amplification and low pass filtering with respect to a difference between a reference voltage of the inner controller circuit and a reference voltage of the hall sensor.

The output buffer 58 comprises a ninth buffer and a tenth buffer which buffer the output signals of the seventh and eighth buffers and output the same.

The signal converter circuit comprises a differential amplification and low pass filter for thereby obtaining an offset voltage and a signal, which does not have a noise component, using a difference between a reference voltage of the inner control circuit and a hall sensor reference voltage. Here, each function module comprises the first through sixth buffers 51 through 56 for thereby obtaining a constancy of a signal flow and a hardware independency, with the first through sixth buffers being separated from each other, so that a failure of a certain function module does not affect other function modules.

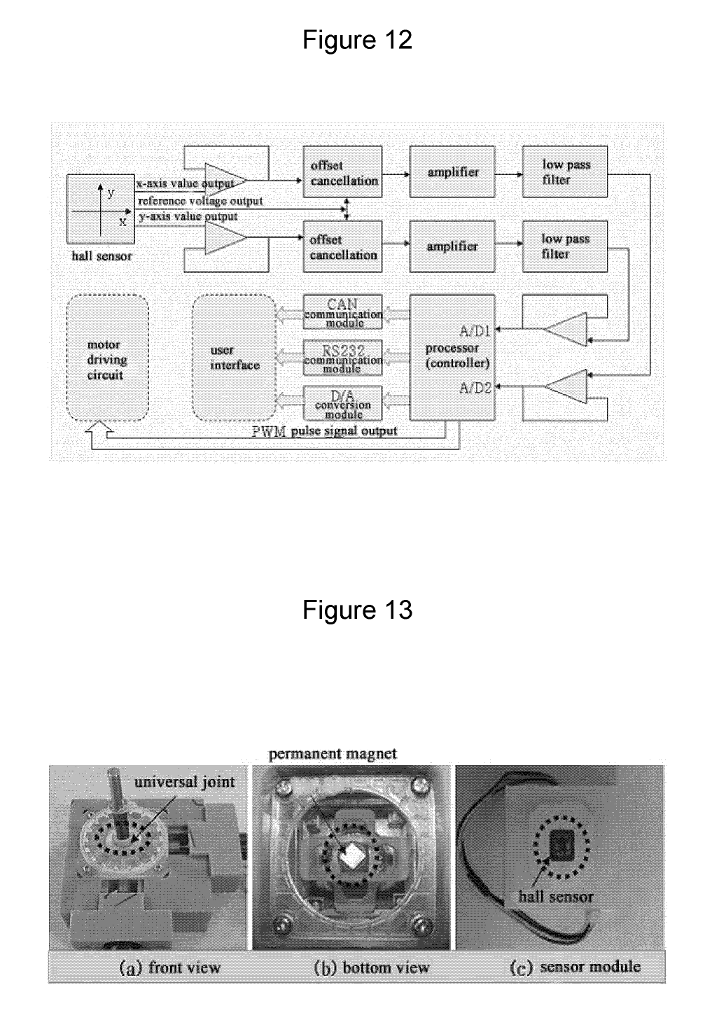

FIG. 12 is a block diagram for describing each function module of a joystick electronic controller according to the present invention.

As shown in FIG. 12, the joystick electronic controller comprises a two-axis hell sensor, a comparator, an offset cancellation unit, an amplifier, a low pass filter, a processor, a CAN module, a RS232 module, a D/A converter, a user interface, a motor drive, etc.

FIG. 13 is a photo of a contactless electron joystick of a universal joint structure using a single hall sensor according to the present invention.

In the present invention, an apparatus of a contactless electron joystick, and an electronic controller are designed using a principle that a rotation of a magnetic field is detected using a single hall sensor (refer to FIG. 12).

A coincidence between a result of an experiment and a simulation is certified based on the least square approximation method by theoretically modeling a nonlinear relation between an actual rotation and a sensor output of a joystick bar.

In addition, the present invention discloses a new compensation method based on the nonlinear compensation equation from a mechanism of the universal joint structure instead of using the conventional least square approximation method.

The electronic controller (FIG. 12) of the developed joystick is modulated with various interfaces such as CAN, RS232, D/A converter, etc. and is well adapted to different applied environments.

In the present invention, it is possible to obtain a linear error characteristic within 1% in the rotation range of the joystick bar and to overcome a mechanical limit of a dual sensor structure and a poor durability problem which occurs due to friction force and vibrations.

As described above, in the contactless electron joystick of a universal joint structure using a single hall sensor according to the present invention, a two-dimension coordinate of an end portion of a joystick bar is obtained using a principle that a rotation of a horizontal vector of a magnetic field is detected using a hall sensor. As shown in FIG. 3, a universal joint structure is adapted for a mechanical structure, and a horizontal vector rotation of a magnetic field with respect to a center axis of a permanent magnet is detected for a sensor mechanism. With the use of a universal joint structure, a joystick structure has less complicity. The performance decrease due to vibrations and friction force may be basically prevented. With its simple construction, failure can be easily diagnosed, and manufacture and assembling process are simple, and work efficiency may be maximized. Enhanced vibration resistance durability can be obtained.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

What is claimed is:

1. A contactless electron joystick of a universal joint structure using a single hall sensor characterized in that a bar shaped permanent magnet engaged at a lower side of a joystick bar helps forming a horizontal vector with respect to a magnetic flux of an axial direction of a bar magnet on a two-dimension plane of a hall sensor in sync with an operation of a universal joint, and the hall sensor detects a formation of the horizontal vector for thereby controlling a direction and speed of a control object.

2. The joystick of claim 1, wherein said contactless electron joystick includes:
an x-axis input buffer which has a first buffer for receiving a signal having a phase difference of 90° corresponding to an x-axis component of a direction of a magnetic field and a second buffer for receiving an inner reference voltage of the hall sensor of an x-direction;
a y-axis input buffer which has a third buffer for receiving a signal having a phase difference of 90° corresponding to a y-axis component of a direction of a magnetic field and a fourth buffer for receiving an inner reference voltage of the hall sensor of a y-direction;
a reference voltage buffer which has fifth and sixth buffers for generating reference voltages of x-direction and y-direction of an inner side of a controller circuit;
a low pass filter which has a seventh buffer for receiving an output signal of the first buffer through its one side and the output signals of the second buffer and fifth buffer from its other side, and an eighth buffer for receiving an output signal of the third buffer and the output signals of the fourth buffer and sixth buffer through its other side, for thereby performing a differential amplification and low pass filtering with respect to a difference between an inner reference voltage of the controller circuit and a reference voltage of the hall sensor; and
a signal converter circuit provided for an output of the hall sensor, said signal converter circuit including an output buffer which has a ninth buffer and a tenth buffer for buffering the output signals of the seventh buffer and the eighth buffer and for outputting the same.

3. The joystick of claim 1, wherein in a nonlinear characteristic between an output signal of the hall sensor and a motion of the joystick bar,
$$A {D}_{x} = ξ \frac{sin ( θ )}{1 + {( k \cdot θ )}^{n}} cos ( α ) , \\ A {D}_{y} = ξ \frac{sin ( θ )}{1 + {( k \cdot θ )}^{n}} sin ( α ) \qquad ( formula 4 )$$
is obtained from the following formulas 1, 2 and 3
$$\begin{matrix}{B}_{h} = λ ( θ ) B sin ( θ ) & ( formula 1 ) \\ λ ( θ ) = \frac{1}{1 + {( k θ )}^{n}} \\ {V}_{x} = c {B}_{x} cos ( α ) = \frac{c λ ( θ ) B cos ( α )}{{D}^{2}} & ( formula 2 ) \\ {V}_{y} = c {B}_{y} sin ( α ) = \frac{c λ ( θ ) B sin ( α )}{{D}^{2}} , and & ( formula 3 ) \\ A {D}_{out} \pm \sqrt{A {D}_{x}^{2} + A {D}_{y}^{2}} = ξ \frac{sin ( θ )}{1 + {( k θ )}^{n}} & ( formula 5 )\end{matrix}$$
is obtained from the above formula 4,
where \vec{B} represents a magnetic flux density of an axial direction of a permanent magnet, and \vec{Bₕ} represents a horizontal vector of a magnetic flux of an axial direction of a permanent magnet, and k is a parameter which determines a linear range, and θ_{c} represents a maximum linear range, and n represents a linearity, and L represents a length of a permanent magnet, and D represents a vertical distance between an end portion of a permanent magnet and a hall sensor, and θ represents an inclination of a joystick bar, and λ(θ) represents a nonlinear function with respect to an inclination of a joystick bar, and α represents a rotation angle of a joystick bar, and ξ represents a constant value which is in constant proportion to an amplification coefficient of a signal converter circuit, and c represents an amplification coefficient of a signal converter circuit, and N represents a resolution of an A/D converter, and V_{ref} represents a reference voltage of an A/D converter.

4. The joystick of claim 3, wherein in said formula 5, said maximum linear range θ_{c} has the following formula,
$${θ}_{c} = \frac{π}{2} [ 1 - exp ( - S \frac{D}{L} ] \qquad ( formula 6 )$$
and, a parameter k, which determines a linear range, has the characteristic of the following formula,
$$k \approx {⌊ \frac{1}{n {θ}_{c}^{n - 1} tan ( {θ}_{c} ) - {θ}_{c}^{n}} ⌋}^{\frac{1}{n}} \qquad ( formula 7 )$$

5. The joystick of claim 4, wherein a constant value ξ, which is in constant proportion to an amplification coefficient of the signal converter circuit, has the following formula,
$$\frac{{V}_{x}}{A {D}_{x}} = \frac{{V}_{y}}{A {D}_{y}} = \frac{c \cdot B}{ξ {D}^{2}} = \frac{{V}_{ref}}{{2}^{N} - 1} \qquad ( formula 8 )$$
based on the formulas 3 and 4, and has the characteristic of the following formula,
$$ξ = \frac{c ( {2}^{N} - 1 ) B}{{D}^{2} {V}_{ref}} . \qquad ( formula 9 )$$

6. The joystick of claim 5, wherein in a nonlinear compensation with respect to an output of the sensor and an inclination of the joystick bar, the following formula 12,
$${θ}_{m + 1} = {θ}_{m} - \frac{A {D}_{out} {k}^{2 n} {θ}_{m}^{2 n} + [ {k}^{n} ξsin ( {θ}_{m} ) - 2 {k}^{n} A {D}_{out} ] {θ}_{m}^{n} + ξsin ( {θ}_{m} )}{[ {k}^{n} ξcos ( {θ}_{m} ) ] {θ}_{m}^{n} - [ n {k}^{n} ξsin ( {θ}_{m} ) ] {θ}_{m}^{n - 1} + ξcos ( {θ}_{m} )}$$
is obtained from the following formulas 10 and 11,
$${x}_{m + 1} = {x}_{m} - \frac{f ( {x}_{m} )}{{f}^{′} ( {x}_{m} )} , m = 0 , 1 , 2 , Λ \qquad ( formula 10 )$$

|xₘ₊₁−xₘ|<ε₁ (formula 11), and thus

|θₘ₊₁−θₘ|<ε₂ (formula 13) is obtained,
where ε₁ represents a set error range, and α₂ represents a set error range.
